(19) United States
(12) Patent Application Publication
(10) Pub. No.: US 2026/0167552 A1
(43) Pub. Date: Jun. 18, 2026

(54) METHOD FOR MACHINING A PREFORM BLANK, PREFORM, AND DEVICE

(71) Applicant: Heraeus Quarzglas GmbH & Co. KG, Hanau (DE)

(72) Inventor: Michael LORENZ, Bitterfeld-Wolfen (DE)

(21) Appl. No.: 19/421,934

(22) Filed: Dec. 16, 2025

(30) Foreign Application Priority Data
Dec. 16, 2024 (EP) 24220172.1

(51) Int. Cl. C03B 37/012

(52) U.S. Cl. CPC C03B 37/01231; C03B 37/01222

(57) ABSTRACT

A method for machining a preform blank, to a method for producing a preform, to a preform, and to a device for machining a preform blank. In a method for machining a preform blank for producing a preform of a multi-core fiber, an eccentric hole is produced in the preform blank using a drill. The hole extends along a longitudinal extent of the preform blank. A position of the preform blank and/or of the drill is selected such that a drift of the drill occurring during drilling causes a change in a position of the hole within a cross section of the preform blank, which change is greater in the azimuthal direction than in the radial direction. In this way, the harmful radial drift component can be minimized, and a preform of particularly high quality can be produced.

### CROSS-REFERENCE TO RELATED APPLICATION

This application claims priority pursuant to 35 U.S.C. 119(a) to European Patent Application No. 24220172.1, filed Dec. 16, 2024, which application is incorporated herein by reference in its entirety.

### BACKGROUND

The invention relates to a method for machining a preform blank for producing a preform of a multi-core fiber, to a method for producing a preform for a multi-core fiber, to a preform for a multi-core fiber, and to a device for machining a preform blank for producing a preform of a multi-core fiber.

For producing optical fibers, a preform is produced first, from which optical fibers are subsequently produced. For producing the preform, a preform blank is drilled. A core bar is subsequently inserted into the hole. In the case of multi-core fibers, a plurality of holes for core bars are made in the preform blank. It is necessary to drill very accurately in order to meet the requirements for the optical properties of the optical fiber to be produced.

During drilling, the drill drifts. On the one hand, as the length increases, the drill is pulled downwards by gravity, which leads to a typically downward drift. Furthermore, other effects also lead to a drift, which can be directed in any direction. The drift can depend, for example, upon the direction of rotation of the drill, the rotational speed of the drill, and the direction of gravity. The effects can superimpose and thus lead to a drift that changes over the length of the hole. It is desirable to produce the longest possible holes with the greatest possible accuracy.

German Patent No. DE10201200610B4 discloses a method for producing a hollow quartz-glass cylinder, in which an end hole running coaxially with the central axis is created in a starting cylinder. The continuously changing drill head position of the drill head is continuously determined by means of a measuring device and, in case of a deviation, is returned to a target position. This is achieved by rotating the starting cylinder about the central axis such that the drill head position is again above the central axis.

European Patent No. EP0777544B1 discloses a method and a device for influencing the trajectory of deep hole drilling. Here, a pressure piece, i.e., a separate body, is positioned between the drill rod and the inner wall of the already produced hole. In this way, the drill rod is bent, and the drilling tool is deflected in a specific direction.

Japanese Patent No. JP5498086B2 describes a deep-drilling method and an associated machine for horizontal drilling. A downward deflection of the drilling tool due to gravity is measured. A control device corrects the position of the tip end of the deep hole drilling tool in order to compensate for the deflection.

U.S. Pat. No. 9,272,337B2 discloses a method for producing a hole through a workpiece with a drill by monitoring the drill alignment and the hole position and adjusting the drilling path as required. Adjusting the drilling path involves selectively applying an axial impulse to the drill when the drill is in a specific azimuthal alignment. The alignment of the drill and the position of the hole are monitored using an acoustic transmitter and receiver, which are moved at the same speed as the drill moves axially through the workpiece.

### SUMMARY

The object of the invention is to improve the production of a preform of a multi-core fiber.

The object is achieved by a method for machining a preform blank according to claim 1, and by a method for producing a preform, a preform for a multi-core fiber, and a device for machining a preform blank according to the adjacent claims. Advantageous embodiments are specified in the dependent claims.

In order to achieve the object, a method for machining a preform blank is used. The preform blank is used to produce a preform of a multi-core fiber. Using a drill, an eccentric hole, which extends along a longitudinal extent of the preform blank, is produced in the preform blank. In particular, a position of the preform blank and/or of the drill is selected such that a drift of the drill occurring during drilling causes a change in a position of the hole within a cross section of the preform blank, which change is greater in the azimuthal direction than in the radial direction.

According to the invention, the aim is not to prevent the drift that occurs during drilling, but to direct the drift in a direction that is less harmful to the multi-core fiber to be produced. It has been shown that a drift that is greater in the azimuthal direction than in the radial direction is significantly less damaging than a drift in the radial direction. In this way, a particularly high-quality preform for a multi-core fiber and, consequently, a particularly high-quality multi-core fiber can be produced with little effort.

A hole is produced using a drill. The drill is in particular a rotating drill. The drill in particular comprises a drill head and/or a drill rod for driving the drill head. The drill rod is usually driven by a motor. Drilling can be carried out by producing a blind hole and, in particular, separating off an unbored end of the particular preform blank-for example, by sawing. In this way, a through-hole can be produced. During the production of the blind hole, the drill is moved relative to the preform blank from an initial drilling position to a final position. Drilling is carried out in particular as thrust drilling, i.e., by advancing a free end of the drill, in particular the drill head of the drill, into the preform blank. However, draw drilling is not ruled out. The drill enters the preform blank, in particular at a first end surface. In particular, drilling is carried out until the drill reaches a position before the second end surface located on the opposite side. Drilling is carried out in particular in a preform blank that is solid at least in the region of the hole to be made. However, it is not ruled out that an existing hole, e.g., one made previously, is enlarged during the drilling.

A preform blank may be solid or at least partially hollow. When producing a hole, one or more centric and/or eccentric holes may already be present, wherein the one or more holes in particular run along the longitudinal extent. A central hole may be present along the central longitudinal axis. The preform blank is made, for example, of quartz glass, in particular of synthetic quartz glass.

An eccentric hole is located off-center with respect to a cross section of the preform blank. The center of the hole is accordingly at a distance from the center of the cross section. The eccentric hole typically also does not run through the central longitudinal axis of the preform blank. In a circular cross section, the center of the cross section is the center of the circle. In a cross section with a circular basic shape, the center of the basic shape can serve as the center. For non-circular cross sections, the center of gravity can serve as the center. In particular, a plurality of holes are produced which, viewed in cross section, lie on a circle, which is called the pitch circle. In particular, the holes are evenly distributed on the circle.

A hole runs along the longitudinal extent of the preform blank. In particular, the hole runs from a first end surface or end face of the preform blank to a second end surface or end face of the preform blank. In principle, it is desirable that a hole to be produced run parallel to the central longitudinal axis of the preform blank at a distance from the central longitudinal axis. However, this is not exactly possible due to drift.

A multi-core fiber is a core fiber with a plurality of cores. The specific number of cores is irrelevant to the method. For example, the multi-core fiber can have two, four, or more cores.

In particular, the preform blank is elongated-for example, cylindrical. The cross section of the preform blank is accordingly identical over the entire longitudinal extent. In one embodiment, the preform blank is circular-cylindrical.

In one embodiment, the preform blank has a circular-cylindrical basic shape. The term “circular-cylindrical basic shape” means that certain deviations from the exact circular-cylindrical shape are permissible. In one example, the preform blank may have a circular-cylindrical basic shape, but may deviate from the exact circular-cylindrical shape due to a flattening. The flattening can extend over the entire length of the preform blank and/or be aligned parallel to the longitudinal axis. A flattening may be present for marking, for example. In another example, the preform blank can have a circular-cylindrical basic shape but may have one or two oblique end surfaces.

The drift of the drill occurs within the preform blank and leads to a change in the position of the hole within the cross section of the preform blank. The position of the hole therefore changes over the longitudinal extent of the preform blank. In other words, the hole “wanders.” The drift leads to a deviation of the actual position of the drill, or of the hole, from the target position and to a deviation of the drill from its starting position. The deviation is, in particular, a radial and/or azimuthal deviation. The position of the preform blank and/or of the drill can be selected such that a drift of the drill occurring during drilling causes a change in the position of the hole within a cross section of the preform blank, which change is greater in the azimuthal direction than in the radial direction. For example, the position of the preform blank and/or of the drill can be selected with respect to the direction of gravity.

If, for example, the drilling begins at the first end surface at a position in the middle between the center of the cross section and the 12 o'clock position at the outer edge of the preform blank, the drill moves from there in a certain direction, e.g., toward the upper right, as the length of the hole increases. At the end of the hole at the second end surface, the drill is then located closer to the outer edge and further to the right, when viewed in the same direction. In this case, the position of the hole in the cross section of the hole changes both in the azimuthal direction and in the radial direction. The radial direction refers to the direction starting from the center of the cross section outwards. The azimuthal direction or circumferential direction refers to an angular position relative to a rotation about the center or the central longitudinal axis.

The change in position in the radial direction, also called the radial component of the drift, has disadvantages. For producing multi-core fibers, a plurality of eccentric holes is typically produced. They are arranged in the cross section of the preform blank, in particular evenly spaced on a pitch circle that is concentric and/or coaxial with the central longitudinal axis. The radial drift causes the diameter of the circle to change over the length of the preform blank. The position of the core bars in the fiber produced therefrom is thus no longer constant, but the core spacing changes, which leads to optical losses of the fiber, as well as splice losses, and impairs the performance of the fiber. In contrast, it has been shown that changing the position in the azimuthal direction or the azimuthal component of the drift does not lead to the described disadvantages. Because the position of the hole is larger in the azimuthal direction than in the radial direction, the disadvantages are minimized with reasonable effort. A high-quality multi-core fiber can be produced.

In order to ensure that the drift runs in a specific direction with respect to the cross section, a suitable position of the preform blank and/or of the drill is selected. For example, the position at which the drill contacts the preform blank, i.e., the relative position of the drill to the preform blank, can be adjusted. This position can influence how the drift runs within the cross section. For example, it may have been shown that the drift runs toward the upper right in the direction of 2 o'clock under certain conditions. If the position at which the drill contacts the preform blank is selected to be the upper left in the direction of 10 o'clock with respect to the center of the cross section, the resulting drift substantially runs in an azimuthal direction or, in other words, leads to a change in position along the circumferential direction.

The adjustment of the position at which the drill contacts the preform blank can be selected or adjusted, for example, by aligning the preform blank and the drill together in space. The common alignment in space refers in particular to a positioning of the drill and of the preform in space such that the drill is arranged with respect to the first end surface in such a way that, by moving the drill and/or the preform blank along a longitudinal axis of the drill and/or of the preform blank, in particular a common longitudinal axis, the hole can be created at the desired location. The drill is generally aligned at least substantially parallel and, in particular, parallel to the preform blank. For example, the drill can be positioned in front of the first end surface.

It can be particularly advantageous to position and/or move the preform blank, and leave the drill stationary. This eliminates the need to move components of the drill, such as the drill bushing, guide bushings, and/or drive unit.

A specific position of the preform blank and/or of the drill is selected. In particular, the position of the preform blank and/or of the drill is also adjusted. In one exemplary embodiment, the preform blank is moved relative to the drill in order to adjust the position. In one exemplary embodiment, the drill is moved relative to the preform blank in order to adjust the position. In one exemplary embodiment, both the preform blank and the drill are moved in order to adjust the position. Moving the drill refers to a different movement than the rotation about the longitudinal axis during drilling, i.e., in particular, an additional movement.

In a first variant, a relative movement can be carried out between the preform blank and the drill, as described above. However, this is not necessary. In a second variant, an identical movement of the preform blank and of the drill can be carried out, during which the relative position between the preform blank and the drill is not changed. For example, the drill can be located just in front of an end surface of the preform blank, above the position where the hole is to be produced. For example, a joint positioning with respect to the central longitudinal axis of the preform blank can be carried out, e.g., by rotating about the central longitudinal axis, in order to adjust a common position in space or with respect to the direction of gravity.

The specific position of the preform blank and/or of the drill cannot be uniformly defined for all holes, since it depends upon the drift, which typically depends upon the specific framework conditions. The drift can depend, for example, upon the direction of rotation of the drill, the rotational speed of the drill, the hole depth, and/or the direction of gravity.

The method is used to machine a preform blank by drilling. A machined preform blank is produced. Once all the holes have been produced in the preform blank and further steps have optionally been carried out, such as the insertion of the core bars, a preform of a multi-core fiber is present. A multi-core fiber can then be produced from the preform.

In particular, the method is carried out in such a way that, in the case of a preform blank with an outer diameter of 200 mm, the change in the position of the hole in the radial direction is at most ±0.3 mm. In particular, the method is carried out in such a way that the change in the position of the hole in the radial direction is at most ±0.15% of the outer diameter.

The method can comprise producing a multi-core fiber from the preform. In particular, the method is carried out in such a way that the change in the position of the hole in the radial direction in the produced multi-core fiber is less than 200 nm.

In one embodiment, the preform blank and the drill are substantially horizontally aligned during drilling, i.e., during the production of the hole. Horizontal drilling requires a significantly lower room height and is therefore usually easier to implement. The selection according to the invention of the position allows maximum accuracy to be achieved despite the increased drift during horizontal drilling.

In one embodiment, the method further comprises adjusting a desired rotational position of the preform blank and of the drill about a longitudinal axis, in particular a central longitudinal axis, of the preform blank. In particular, a rotational position of the preform blank and/or of the drill is changed with respect to the longitudinal axis in order to direct the drift in the desired direction. A rotational position refers to a position in which the preform blank or the drill is arranged at a specific angle with respect to the respective axis. The change in the rotational position can be achieved by rotating about the longitudinal axis or about an axis parallel thereto.

In one embodiment, the drill and/or the preform blank is moved in order to adjust the rotational position. In one embodiment, the drill and/or the preform blank is rotated about the longitudinal axis. This allows a position of the drill and of the preform blank to be adjusted with respect to the direction of gravity. The gravity-induced drift can thus be directed in the desired direction.

In one embodiment, the position of the preform blank and of the drill is such that the drill is at a position other than exactly above a central longitudinal axis of the preform blank, with respect to the direction of gravity. In other words, the drill is not exactly above the central longitudinal axis of the preform blank. Preferably, an angle between the vertical and the position of the drill, starting from the central longitudinal axis, is at least 10°, in particular at least 20°. For example, the relative position of the drill and/or of the preform blank with respect to the direction of gravity is located between 9 o'clock and 12 o'clock, e.g., between 9:30 and 11:30—in one embodiment, between 10 o'clock and 11 o'clock.

It has been shown that the drift often acts not only vertically downwards, but also or even primarily in another direction. The off-center position of the drill can therefore be particularly effective in directing the resulting drift in a suitable direction.

In one embodiment, the position of the preform blank and/or of the drill that is to be selected is determined based upon at least one previously determined direction of the drift.

The prior determination of the drift can be carried out, for example, by estimation based upon experience and/or based upon measured values. It is possible, for example, to use experience gained under similar conditions where, for example, the same drill, the same material, the same drilling position, the same rotational speed, and/or the same feed rate, etc., were used. In other words, the expected drilling path is determined in advance and used as input in order to select the desired position of the preform blank and/or of the drill. The drift can also be determined by making a test hole.

In one embodiment, before producing the hole, a test hole is produced in a test preform blank, and at least one direction of the drift in the test hole is determined.

The determined direction is then used to select the particular position. If, for example, a drift from the starting center of the borehole toward the upper right in the direction of o'clock occurs, the position of the preform blank and/or of the drill can be selected such that the preform blank and the drill, starting from the position at the test hole, are rotated counterclockwise by 60°, e.g., about the central longitudinal axis of the preform blank. In this way, the resulting drift leads to a change in position along the circumferential direction or on the pitch circle. The change in position in the radial direction becomes minimal. This adjustment can be carried out by moving, e.g., by shifting and/or rotating, the preform blank and/or the drill, For example, the preform blank and drill can be rotated together about the central longitudinal axis, an axis parallel thereto, and/or a horizontal axis.

In particular, the test hole is produced using the same drill. In particular, the test preform blank is produced at least substantially from the same material as the preform blank. In particular, other parameters are selected analogously, such as the drilling position, the rotational speed, and/or the feed rate, etc.

After determining the direction of the drift in a test hole, a plurality of holes can be produced using the determined position of the preform blank and/or of the drill.

In one embodiment, between the production of a first portion of the hole and the production of a second portion of the hole, the position of the preform blank and/or of the drill is changed. In one embodiment, the relative position between the preform blank and the drill remains the same. The change in position can be carried out by rotating the preform blank and the drill-for example, about an axis parallel to the central longitudinal axis, e.g., about the central longitudinal axis itself. The movements of the preform blank and of the drill can, in principle, be carried out, at least in intervals, at the same time, e.g., jointly, or successively. The joint movement has the advantage that the drilling process does not have to be interrupted or has to be interrupted only minimally. The drill does not need to be removed from the completed portion of the hole.

The portions of the hole lie axially one behind the other. The portions of the hole are made successively. A change in position is carried out between two portions of the hole. The position can be changed while the drill is inactive. The position can be changed while the drill is drilling. In one exemplary embodiment, the hole is made in three or more portions, e.g., four, five, six, eight, or ten portions, between which the position is changed in each case.

A temporary change in position can compensate for a temporarily changed drift direction. This allows the component of radial drift to be minimized particularly effectively. For example, the component of gravity-induced downward drift becomes effective only at greater drilling lengths. This component can be compensated for in a targeted manner, and longer holes can be produced with high accuracy.

In a further embodiment, the common position of the preform blank and of the drill in space is changed, at least in intervals, at the same time as the hole is produced. Thus, during drilling, the position of the preform blank in space and the position of the drill in space are changed simultaneously. In particular, the preform blank and the drill are rotated about an axis that is parallel to a longitudinal axis of the preform blank and/or of the drill, or about a horizontal axis. A continuous process is provided in which the drift is influenced at any given time in such a way that the harmful radial component is minimized. This allows the object to be achieved more effectively.

In one embodiment, after the hole has been produced, the preform blank is rotated about its longitudinal axis, in particular its central longitudinal axis, relative to the drill. In particular, an additional hole is subsequently produced. In particular, the preform blank is rotated. In this way, a plurality of eccentric holes can be produced successively. This allows for the particularly efficient production of a preform. The position of the preform blank and/or of the drill for influencing the drift can remain the same or be changed between and/or during the individual drilling operations.

In one embodiment, the position of the preform blank and/or of the drill in space is selected such that the change in the position of the hole in the azimuthal direction is greater by a factor of at least 2, in particular at least 4, than in the radial direction.

The factor is in particular at least 3, preferably at least 5. In one embodiment, the factor is at least 7, at least 10, and in one example at least 15. This allows for a particularly low radial drift to be adjusted. For calculating the factor, the same unit is in particular used for the change in the azimuthal direction and in the radial direction-for example, millimeters.

In one embodiment, a ratio of a length of the preform blank to a diameter of the hole is greater than 10, in particular greater than 20. The ratio can be greater than 30—for example, greater than 35. The ratio can be greater than 40 or 50. As the ratio of the length of the preform to the diameter of the hole increases, the drift also increases, which counteracts the required accuracy. The solution according to the invention makes such ratios possible with high accuracy. Such ratios ensure short processing times and minimal setup times.

In one embodiment, a plurality of holes are produced. In one embodiment, the drift of the plurality of holes in the azimuthal direction has at least substantially the same magnitude. In particular, the drift of the plurality of holes in the azimuthal direction has the same direction in the sense of the same sign, i.e., it does not point in opposite directions. In a plurality of holes or in all holes, the drift, therefore, proceeds either clockwise or counterclockwise relative to the center of the cross section of the preform blank. In this way, the distance between the holes remains constant over the length of the preform. This minimizes optical losses and splice losses.

A further aspect of the invention is a method for producing a preform for a multi-core fiber, comprising the method according to the invention. In particular, a plurality of eccentric holes are produced. The method may comprise inserting core bars into the holes. All the advantages, features, and embodiments of the method described above can apply analogously to this method, and vice versa.

A further aspect of the invention is a preform for a multi-core fiber, which can be produced or producible using the method according to the invention. The preform contains an eccentric hole that extends along a longitudinal extent of the preform. The position of the hole within a cross section of the preform changes over the longitudinal extent of the preform. The cross section of the preform corresponds to the cross section of the preform blank. A change in position, viewed in the cross section of the preform, is greater in the azimuthal direction than in the radial direction. This allows for a substantially constant distance between a plurality of eccentric holes. The preform can comprise core bars inserted into the holes. All the advantages, features, and embodiments of the methods described above can apply analogously to the preform, and vice versa.

In particular, both the beginning and the end of the hole are located on a pitch circle with the same diameter in the corresponding cross section. In particular, each point between the beginning and the end of the hole is located on a corresponding circle with the same diameter. In this ideal embodiment, the drift occurs exclusively in the azimuthal direction, and the drift in the radial direction is zero. The change in the position of the hole is measured in the cross section, i.e., transversely to the longitudinal extent. The change in the position of the hole is in particular continuous, i.e., not abrupt.

In one embodiment, a length of the preform is more than 1.5 m, in particular at least 2.0 m. The length can be at least 2.5 m. Such a length can be produced with the required accuracy using the method according to the invention.

In one embodiment, the preform contains at least two eccentric holes that extend along the longitudinal extent of the preform and whose positions within the cross section change over the longitudinal extent of the preform. In particular, a distance between the holes, measured in cross section, is substantially constant over the longitudinal extent. The holes may be twisted slightly against one another, which has proven not to be harmful to the optical fiber.

In one embodiment, a distance between a central longitudinal axis of the preform and a center of the hole at a first end surface of the preform and at a second end surface, opposite the first end surface, of the preform is substantially the same. In other words, the change in the position of the hole in the radial direction is approximately zero. A deviation of at most 1%, in particular at most 0.5% or at most 0.2%, of the diameter of the preform blank may be permissible.

Preferably, the change in the radial direction is smaller by a factor of at least 2, in particular at least 4, than the change in the azimuthal direction.

In a further embodiment, the preform contains at least two eccentric holes, which extend along the longitudinal extent of the preform. The positions of the holes change over the longitudinal extent of the preform, within the cross section of the preform, in the same direction along a curved line about a central longitudinal axis of the preform. Ideally, the curved line can be a circular path. In particular, the distances between two adjacent holes are substantially constant over the length of the preform. A deviation of at most 5%, in particular at most 2% or at most 1%, of the diameter of the preform blank may be permissible.

A further aspect of the invention is a device for machining a preform blank. The preform blank is used to produce a preform of a multi-core fiber. The device comprises a holding device for holding a preform blank, a drill for producing an eccentric hole in the preform blank, and a positioning device which is designed to move the holding device and/or the drill in order to adjust a position of the preform blank and/or of the drill such that a drift of the drill occurring during drilling causes a change in a position of the hole within a cross section of the preform blank, which change is greater in the azimuthal direction than in the radial direction. All the advantages, features, and embodiments of the methods described above and of the preform can apply analogously to the device, and vice versa.

The device is in particular designed to carry out the method according to the invention and/or to produce a preform according to the invention. The holding device is in particular designed to hold the preform blank in an at least substantially horizontal alignment. The drill is, in particular, at least substantially horizontally aligned.

The positioning device can be designed to move the drill and the holding device together. The movement of the drill and/or of the holding device can be a rotation. The rotation can be carried out about a central longitudinal axis of the preform blank held in the holding device or about an axis parallel thereto. The positioning device may comprise a drive in order to move the drill and/or the holding device.

In one embodiment, the positioning device is designed to rotate the preform blank about a central longitudinal axis of the preform blank. In this way, a relative rotational position of the preform blank and of the drill with respect to the central longitudinal axis can be adjusted particularly easily.

Alternatively or additionally, the positioning device can be designed to move the preform blank or the drill in space. This can be achieved, for example, by two translational movements perpendicular to one another in the cross-sectional plane of the preform blank. Typically, the drill is stationary, apart from the rotation about its longitudinal axis and the feed required to produce the hole, and the preform blank is positioned and/or moved relative to the drill. By appropriately arranging the longitudinal axis of the drill and the longitudinal axis of the preform blank, the direction of the drift can be adjusted as desired. The positioning device serves in particular to adjust a different relative position of the preform blank with respect to the drill after a hole has been produced, in order to be able to produce an additional hole, in which the drift is also directed in the desired manner. This allows all the holes of the preform to be produced successively.

The hole trajectory can be determined using ultrasound, CT analysis, and/or, if necessary, an optical measurement method. The holding device may comprise a V-block for holding the preform blank. The device can furthermore comprise a cutting oil supply apparatus. The drill can be a drill for a BTA drilling method. In this case, a cooling and lubricating agent is supplied externally, and the generated chips are removed internally. The device comprises a cutting oil supply apparatus (BOZA) for supplying the cooling and lubricating agent. A seal is preferably implemented on the workpiece.

Exemplary embodiments of the invention are also explained in greater detail below with reference to figures. Features of the exemplary embodiments can be combined individually or in a plurality with the claimed subject matter, unless otherwise indicated. The claimed scope of protection is not limited to the exemplary embodiments.

### BRIEF DESCRIPTION OF THE DRAWINGS

The figures show:

FIGS. 1 and 2 show cross-sectional drawings of preforms;

FIG. 3 shows a schematic representation of a drilling process;

FIG. 4 shows a schematic representation before the beginning of a drilling process;

FIGS. 5 and 6 show schematic representations of a device;

FIGS. 7 to 9 show schematic representations of method steps for machining a preform blank;

FIGS. 10 and 11 show schematic representations of drift in drilling processes; and,

FIGS. 12 and 13 show schematic representations of method steps.

### DETAILED DESCRIPTION OF THE INVENTION

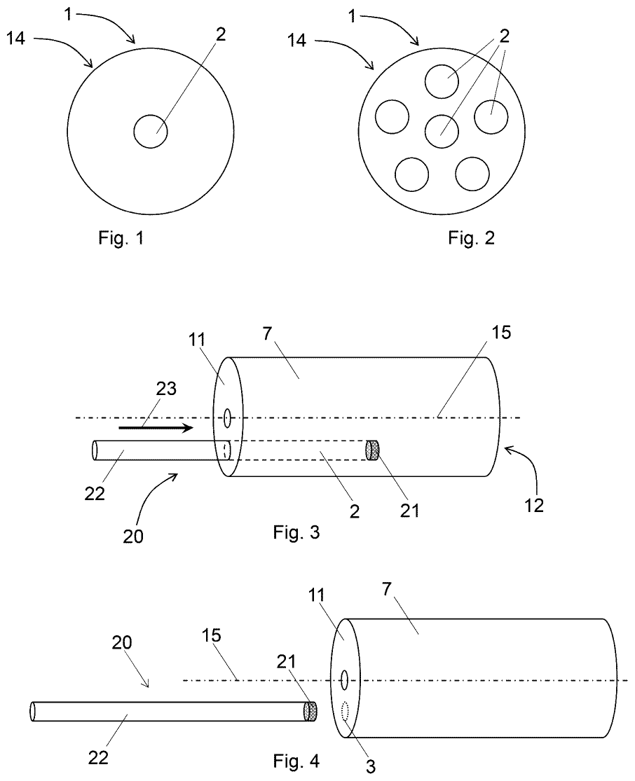

FIGS. 1 and 2 show, by way of example, cross sections 14 of different preforms 1. The preforms each have a circular cross section 14. The preforms 1 optionally contains a central hole 2, which runs along the central longitudinal axis of the corresponding preform 1.

FIG. 2 shows, by way of example, five eccentric holes 2 in addition to the optional central hole 2. These eccentric holes are, for example, regularly distributed on a pitch circle (not marked separately), which can be arranged concentrically with the outer contour of the preform 1 and/or coaxially with the central longitudinal axis of the preform 1.

FIG. 3 schematically shows a drilling process for producing a hole 2 in a preform blank 7. A drill 20 is moved along a direction 23 parallel to the longitudinal axis 15 of the preform blank 7 and in the process rotates in particular about its longitudinal axis. The drill 20 typically comprises a drill head 21, which is driven by a drill rod 22. These components are shown here purely schematically; usually, the drill rod 22 has a smaller diameter than the drill head 21. The drill rod 22, for example, is driven by a drive unit not shown.

It is evident that the drill 20 has penetrated the preform blank 7 at the first end surface 11 and from there produces the hole 2. The hole 2 is an eccentric, i.e., off-center, hole. The longitudinal axis of the drill 20 is aligned parallel to the central longitudinal axis 15 of the preform blank 7. The position in which the drill 20 contacts the first end surface 11 or enters the cross section of the preform blank 7 is shown here, purely by way of example, at 6 o'clock in the viewing direction along the direction 23.

FIG. 4 shows a situation before the beginning of the eccentric drilling. The preform blank 7 may optionally already contain a central hole. The drill 20 is positioned in front of the first end surface 11 such that it can perform the drilling by a translational movement along its longitudinal axis or the central longitudinal axis 15. On the first end surface 11, the drilling position 3 of the borehole to be produced is marked with dotted lines.

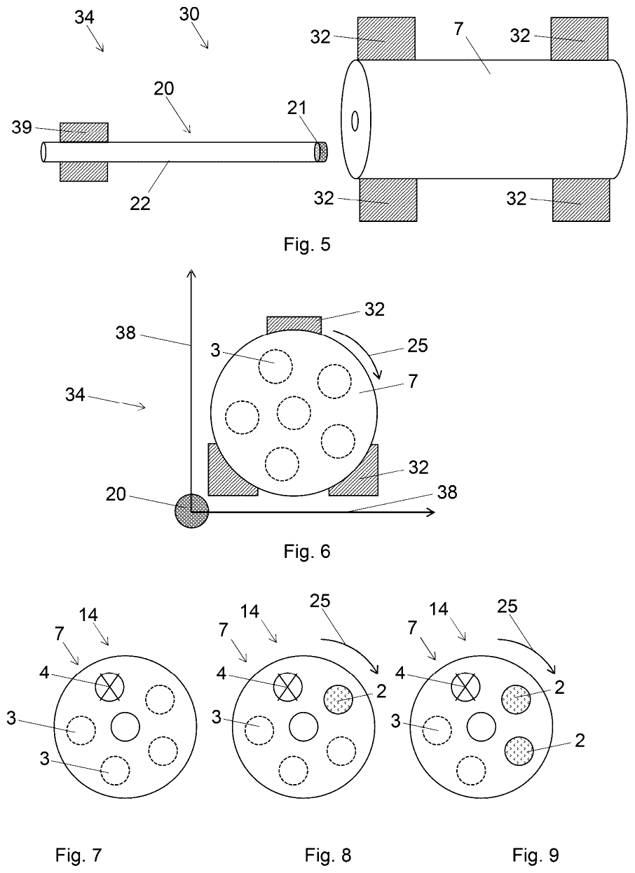

FIGS. 5 and 6 show schematic representations of some components of a device 30. The preform blank 8 is held by elements of a holding device 32. The holding device 32 can be used to rotate the preform blank 7 about its central longitudinal axis. For example, a position of the preform blank 7, possibly together with the position of the drill 20, can be adjusted according to the invention. The holding device can accordingly be part of a positioning device 34.

The holding device 32 can also be used to adjust the position of the preform blank 7 with respect to the drill 20—for example, in order to be able to produce a second eccentric hole after producing a first eccentric hole, as shown below in FIGS. 7 to 9. Alternatively or additionally, the holding device 32 can be designed to move the preform blank 7 within the plane perpendicular to its longitudinal extent. For example, the holding device 32 comprises two translation devices 38 perpendicular to one another, as shown schematically in FIG. 6. The holding device 32 can interact with a positioning device 34 in order to move the holding device 32. Alternatively or additionally, the holding device 32 holds the preform blank 7 in a fixed position.

The drill 20 is held by an optional drill holder 39, which can be used to move the drill 20 within the plane perpendicular to its longitudinal extent. For example, the drill holder 39 comprises two translation devices 38 perpendicular to one another, as shown schematically in FIG. 6. Translation devices 38 for the preform blank 7 and/or translation devices 38 for the drill 20 may thus be present. The drill holder 39 can be used to move the drill 20 relative to the preform blank 7 in order to adjust the position according to the invention. The drill holder 39 can be part of a positioning device 34 in order to move the holding device 32 and/or the drill 20. The positioning device 34 can comprise or consist of the drill holder 39. The drill holder 39 can be used to advance the drill 20 along its longitudinal axis during drilling.

Using cross sections 14 of a preform blank 7, FIGS. 7 to 9 show method steps for producing a preform. For example, based upon previously made test holes or based upon experience with a comparable system, it is known that a drift of the drill toward the upper right in the direction of one o'clock is to be expected. This could have been determined at any drill position.

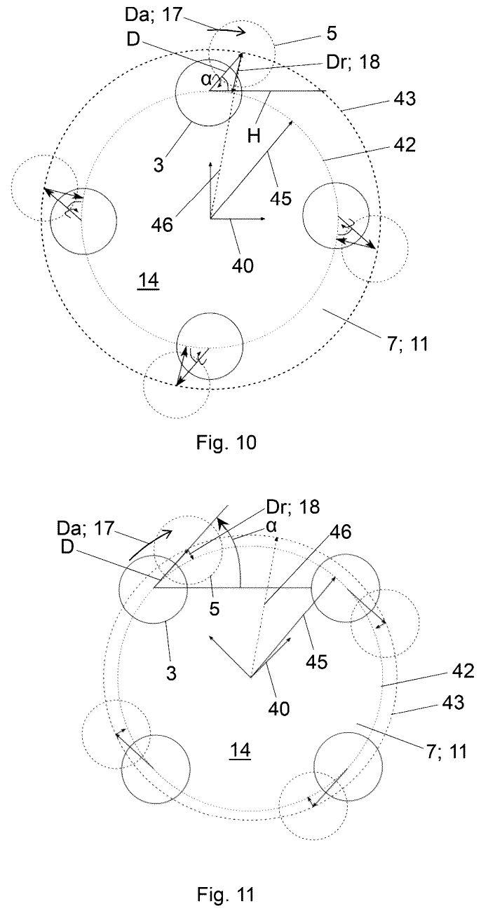

In order to direct the drift with respect to the cross section 14 of the preform blank 7 in a desired direction (cf. in this regard FIGS. 10 and 11 below), the position of the preform blank 7 and/or the drill position 4 marked with a cross was selected such that drilling in the cross section 14 is not carried out vertically above the center of the cross section, corresponding to the central longitudinal axis of the preform blank 7. Instead, the drill position was shifted slightly to the lower left to approximately 11 o'clock in order to minimize the radial component of the shift. In particular, all holes 2 are created in this position.

Before the first hole is produced, the required position can be adjusted by positioning or moving the preform blank 7 and/or the drill. The preform blank 7 can be moved translationally, i.e., shifted, e.g., in the plane of its cross section 14, and/or rotated about an axis of rotation aligned—for example, parallel to the central longitudinal axis. Alternatively or additionally, the drill can be moved translationally, i.e., shifted, e.g., in the plane of its cross section 14, and/or rotated about an axis of rotation aligned—for example, parallel to the central longitudinal axis.

FIG. 7 shows the situation before or during the execution of the first, eccentric drilling. Optionally, a central hole may have been created beforehand. The drill is located at the drill position 4, marked with a cross, so that the hole can be produced by translation along the central longitudinal axis. Furthermore, drilling positions 3, where holes are also to be created, are marked with dashed lines.

After the hole is produced, a movement takes place, which corresponds to a clockwise rotation 25 of the preform blank 7 about the central longitudinal axis of the preform blank 7 at a defined angle. This is shown in FIG. 8. With the boreholes arranged evenly spaced here, the angle is calculated as 360°/n, where n is the number of boreholes to be produced. Here, five boreholes are to be created purely by way of example; the angle is therefore 72°. After rotation, the completed hole 2 is arranged at the upper right at approximately two o'clock, and the drill position 4 is located in front of the next hole to be produced, at approximately 11 o'clock.

In order to change the angle, it is simple and practical to rotate the preform blank 7 about its central longitudinal axis as shown. The drill can then remain stationary. However, it is not ruled out, instead or in addition, to move the preform blank, to rotate it about a different axis, and/or to move and/or rotate the drill. The position of the drill and of the preform blank in space can remain the same or change. Critical is only that, relative to the direction of gravity, the same relative position of the preform blank 7 to the drill be adjusted, i.e., approximately 11 o'clock here, so that the drift can again be directed as desired.

The step described above is repeated, as shown in FIG. 9, in order to create the next hole 2. After two further repetitions not shown, all holes 2 are completed.

FIGS. 10 and 11 show cutouts of cross sections 14 of preforms to illustrate the drift in conventional methods (FIG. 10) and in the method according to the invention (FIG. 11). By way of example, four holes which are evenly spaced on a pitch circle in the cross section 14 are to be created. This pitch circle is shown as the inner target pitch circle 43 with dotted lines. The drill positions 3 marked with solid lines are located such that the center of each drill hole lies on the target pitch circle 43. The representation shows a top view of the first end surface where the drilling starts. The drill position is located centrally above the center of the cross section here. Ideally, the hole should end at the same point on the same pitch circle on the opposite second end surface.

However, a drift results, which leads to deviating positions of the holes at the point where the drill is located at the end or after the hole has been produced. These positions are shown using the final positions 5 of the drill marked with dashed lines. It is evident that the drill moves toward the upper right during the drilling process, viz., according to the angle α with respect to the horizontal H, which is perpendicular to the direction of gravity. The resulting drift D, the radial component Dr, and the azimuthal component Da are shown. The radial component Dr runs in the radial direction 18, and the azimuthal component Da runs in the azimuthal direction 17. Furthermore, a coordinate system 40 is shown, the origin of which lies at the center of the cross section. Starting therefrom, the target radius 45 and the actual radius 46 of the particular pitch circle are shown. The target radius 45 of the target pitch circle 42 is the radius present at the first end surface 11. The actual radius 46 of the actual pitch circle 43 is the radius present at the second end surface and shifted due to the drift. The radial component Dr corresponds to the effective change in radius.

FIG. 11 shows the same situation when a position of the preform blank 7 and/or of the drill is adjusted such that the drift causes a change in the position of the hole within the cross section 14, which change is greater in the azimuthal direction 17 than in the radial direction 18. The designations are the same as in FIG. 11, such that only the differences will be discussed.

The angle α is the same. However, due to the selected relative position of the drill and of the preform blank 7 with respect to the direction of gravity, which here corresponds, by way of example, to a drilling position 3 between 10 o'clock and 11 o'clock. It is evident that the drift D has the same magnitude and direction as in the situation shown in FIG. 10. However, due to the changed position, the radial component Dr is significantly smaller, and the azimuthal component Da is significantly larger. The ratio of Da to Dr is approximately 3.8. The actual pitch circle 43 deviates significantly less from the target pitch circle 42. In this way, the quality of the preform and thus of the optical fiber produced therefrom can be significantly improved. It is also evident that a further counterclockwise rotation of the relative position of the drill and of the preform blank, i.e., a change in the azimuthal position of the drill position with respect to the direction of gravity, would make a further reduction of the radial component Dr possible. The drift would then run tangentially to the target pitch circle 42 and have only a minimal radial component.

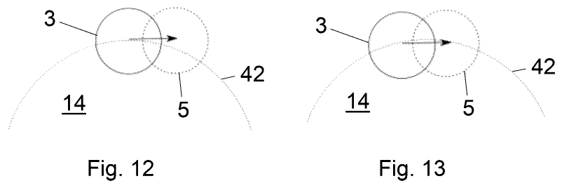

FIGS. 12 and 13 similarly show cutouts of a cross section 14. Arrows indicate the drift from the drilling position to the final position 5 in each case. The figures are rotated about the center of the cross section 14 for illustrative purposes and deviate from the actual conditions. FIG. 12 substantially corresponds to the situation in FIG. 11 or to a further optimized relative position in which a desired position is adjusted once before drilling, and a tangential drift is present, so that a certain radial component of the drift is still present.

In FIG. 13, however, a continuous or quasi-continuous change in position has occurred. For example, after the production of the first portion of the hole, the drill and the preform blank were rotated together and/or simultaneously, and a further portion of the hole was subsequently produced. This corresponds to a quasi-continuous process and can have been repeated any number of times. Alternatively or additionally, the drill and the preform blank may have been rotated together and simultaneously in space and/or with respect to the direction of gravity during drilling. This corresponds to a continuous process. This results in a continuously adapted drift, which ultimately proceeds exclusively azimuthally, as indicated by the simplified straight arrow.

Basically, a distinction can be made between a predictable drift and an unpredictable drift. The drift that occurs overall can be understood as a superposition of predictable drift and unpredictable drift. Information about predictable drift, such as the direction of the drift, can be determined before drilling, for example. This is possible, for example, by making a test hole under the same or similar conditions. Furthermore, an unpredictable drift may occur.

In one embodiment, a position of the drill and/or a resulting drift is determined. This can be carried out during drilling and/or continuously. A measurement, which can be referred to as an online measurement, can be performed during drilling. For example, information regarding the position of a portion of the drill can be determined. A measuring device may be available to determine such a position. For example, the position of at least one portion of the drill can be measured, preferably with respect to or within the cross section of the preform blank. The determination can be carried out as described in German Patent Application No. 102012006410.

When selecting the position of the preform blank and/or of the drill, the measured position and/or drift can be taken into account. The position of the preform blank and/or of the drill can be changed based upon the measured position or drift. This can be carried out during drilling and/or between the production of two portions of the hole. In this way, the hole trajectory can be influenced. The unpredictable drift can thus be addressed.

It can be determined, in particular during drilling, when a change in position is necessary in order to reach a specific target. If a change is necessary, the position can be changed. For example, a change can be made if a threshold value is exceeded. The target can, for example, be a drift that is greater in the azimuthal direction than in the radial direction, possibly by a certain factor as described, or a maximum absolute drift in the radial direction.

Substantially horizontal means that certain deviations from the horizontal alignment are permissible. The deviations from the horizontal alignment are typically no more than 15°, preferably no more than 10°.

### LIST OF REFERENCE SIGNS

Preform 1
Hole 2
Drilling position 3
Drill position 4
Final position 5
Preform blank 7
First end surface 11
Second end surface 12
Cross section 14
Central longitudinal axis 15
Azimuthal direction 17
Radial direction 18
Drill 20
Drill head 21
Drill rod 22
Direction 23
Rotation 25
Device 30
Holding device 32
Positioning device 34
Translation device 38
Drill holder 39
Coordinate system 40
Target pitch circle 42
Actual pitch circle 43
Target radius 45
Actual radius 46
Drift D
Radial component Dr
Azimuthal component Da
Horizontal H
Angle α

What us claimed is:

1. A method for machining a preform blank for producing a preform of a multi-core fiber, in which an eccentric hole is produced in the preform blank using a drill, which hole extends along a longitudinal extent of the preform blank, wherein a position of the preform blank and/or of the drill is selected such that a drift of the drill occurring during drilling causes a change in a position of the hole within a cross section of the preform blank, which change is greater in the azimuthal direction than in the radial direction.

2. The method according to the claim 1, wherein the preform blank and the drill are substantially horizontally aligned.

3. The method according to claim 1, further comprising adjusting a desired rotational position of the preform blank and of the drill about a central longitudinal axis of the preform blank.

4. The method according to claim 1, wherein the position of the preform blank and of the drill is such that the drill is located in a position other than exactly above a central longitudinal axis of the preform blank, with respect to the direction of gravity.

5. The method according to claim 1, wherein the position of the preform blank and/or of the drill that is to be selected is determined based on at least one previously determined direction of the drift.

6. The method according to claim 1, wherein, before producing the hole, a test hole is produced in a test preform blank and at least one direction of the drift in the test hole is determined.

7. The method according to claim 1, wherein the position of the preform blank and/or of the drill is changed between the production of a first portion of the hole and the production of a second portion of the hole.

8. The method according to claim 1, wherein the common position of the preform blank and of the drill in space is changed, at least in intervals, at the same time as the hole is produced.

9. The method according to claim 1, wherein, after the production of the hole, the preform blank is rotated about its central longitudinal axis relative to the drill and subsequently an additional hole is produced.

10. The method according to claim 1, wherein the position of the preform blank and/or of the drill is selected such that the change in the position of the hole is greater in the azimuthal direction than in the radial direction by a factor of at least 2, in particular at least 4.

11. A method for producing a preform for a multi-core fiber, comprising the method according to claim 1.

12. A preform for a multi-core fiber, which can be produced by the method according to claim 1, wherein the preform contains an eccentric hole which extends along a longitudinal extent of the preform, wherein a position of the hole within a cross section of the preform changes over the longitudinal extent of the preform, wherein a change in position, viewed in the cross section of the preform, is greater in the azimuthal direction than in the radial direction.

13. The preform according to claim 1, wherein the preform contains at least two eccentric holes which extend along the longitudinal extent of the preform, and the positions of which change over the longitudinal extent of the preform, within the cross section of the preform, in the same direction along a curved line about a central longitudinal axis of the preform.

14. A device for machining a preform blank to produce a preform of a multi-core fiber, comprising a holding device for holding a preform blank, a drill for producing an eccentric hole in the preform blank, and a positioning device which is designed to move the holding device and/or the drill in order to adjust a position of the preform blank and/or of the drill such that a drift of the drill occurring during drilling causes a change in a position of the hole within a cross section of the preform blank, which change is greater in the azimuthal direction than in the radial direction.

15. The device according to claim 14, wherein the positioning device is designed to rotate the preform blank about a central longitudinal axis of the preform blank.

16. The method according to claim 2, further comprising adjusting a desired rotational position of the preform blank and of the drill about a central longitudinal axis of the preform blank.

17. The method according to claim 2, wherein the position of the preform blank and of the drill is such that the drill is located in a position other than exactly above a central longitudinal axis of the preform blank, with respect to the direction of gravity.

18. The method according to claim 3, wherein the position of the preform blank and of the drill is such that the drill is located in a position other than exactly above a central longitudinal axis of the preform blank, with respect to the direction of gravity.

19. The method according to claim 2, wherein the position of the preform blank and/or of the drill that is to be selected is determined based on at least one previously determined direction of the drift.

20. The method according to claim 3, wherein the position of the preform blank and/or of the drill that is to be selected is determined based on at least one previously determined direction of the drift.
